(19) United States
(12) Patent Application Publication
(10) Pub. No.: US 2010/0089614 A1
(43) Pub. Date: Apr. 15, 2010

(54) ELECTRIC CONTROL CABLE AND AN ASSOCIATED FABRICATION METHOD

(76) Inventors: Francis Debladis, Sainte Catherine Les Arras (FR); Jérôme Fournier, Lyon (FR); Olivier Schuepbach, Dombresson (CH)

Correspondence Address: SOFER & HAROUN LLP., 317 MADISON AVENUE, SUITE 910, NEW YORK, NY, 10017, US

(21) Appl. No.: 12/443,505

(22) PCT Filed: Oct. 8, 2007
(86) PCT No.: PCT/FR07/52095

§ 371 Date: Dec. 14, 2009

(30) Foreign Application Priority Data
Oct. 11, 2006 (FR) 06 54187

(51) Int. Cl. H01B 5/14; B05D 5/12

(52) U.S. Cl. 174/126.4; 427/117

(57) ABSTRACT

The present invention relates to an electric control cable of the type comprising a core of polymer material and a plurality of copper strands extending in the longitudinal direction of said core, said copper strands being distributed uniformly and concentrically on the periphery of said core so as to penetrate only partially into said core, with each of them leaving a portion that is accessible from outside said periphery. According to the invention, said copper strands are embedded in part in the material forming the core and extend parallel to the longitudinal direction of said core. Advantage: fabrication is simplified and copper is saved, while still enabling easy access to the copper for subsequent crimping of the cable for connection purposes.

### FIELD OF THE INVENTION

The present invention relates to electric control cables.

### BACKGROUND OF THE INVENTION

Such cables are used in various fields of industry, such as for example the automobile industry, where they are assembled in bundles for electrically powering various pieces of equipment. These cables need in particular to be as lightweight as possible and to be compact, while nevertheless conserving good mechanical strength.

Such cables are conventionally made up of a plurality of copper strands, generally twisted so as to increase the flexibility of the cable, and surrounded by an insulating sheath, e.g. obtained by extrusion. FIG. 1 shows an example of such a cable, seen in cross-section, and made using seven identical strands of copper 20 that are surrounded by an insulating sheath 30 of circular section. To give an idea, the diameter of the cable is typically about 1.6 millimeters (mm) and each of the copper strands 20 presents a diameter of about 0.3 mm.

The advantages of a cable having the above structure lie essentially in the simplicity of its fabrication method, and also in the fact that it enables connectors to be crimped on reliably. It suffices to strip the insulating sheath 30 where it is desired to place a connector, and then to compress the bushing of the connector mechanically around the section of the stripped cable. The structure of the braided copper strands guarantees contact between the bushing and said copper strands.

In contrast, it is found that the above cable makes use of more copper than it really needs in terms of the quantity of electric current that is to be conveyed by the cable. More precisely, about half of the copper in the above cable structure is used for increasing the traction strength of the cable, and also for guaranteeing effective crimping.

Unfortunately, copper is becoming more expensive and it is important to find novel cable structures that minimize the quantity of copper used.

Various solutions are already known for composite cables in which copper strands are combined with a core of non-conductive material.

Document US 2005/0199414 in particular describes a plurality of embodiments of composite cables seeking to reduce the amount of copper used. One of those embodiments proposes embedding a plurality of copper strands within a matrix of plastics material, e.g. a polyamide. Nevertheless, with such a structure, operations of connecting connectors to the cable not easy to perform, and reliable crimping is not guaranteed. In addition, that embodiment makes use of four copper strands that are situated substantially at the center of the matrix, without making contact with the copper strands situated at the periphery of the matrix, and they are thus useless.

That document proposes another embodiment in which the copper strands extend in the longitudinal direction of a core made of non-conductive material, and are uniformly distributed over the entire periphery of the core. That ensures assembling connectors by crimping is simpler to perform and above all more reliable. Nevertheless, the number of copper strands to be used remains large since the strands cover the entire periphery of the core. That increases difficulty in making the cable.

Finally, document DE 25 16 830 discloses a cable in which a plurality of conductor strands are distributed uniformly and concentrically on the periphery of a core in such a manner as to penetrate only partially into said core, each strand offering a portion that is accessible from outside the core. The strands in that cable are twisted around the core.

### OBJECT AND SUMMARY OF THE INVENTION

The object of the present invention is to propose a novel structure for a control cable that is compact, lightweight, has very good traction strength, and is of simplified fabrication.

Thus, the present invention provides an electric control cable of the type comprising a core of polymer material and a plurality of copper strands extending in the longitudinal direction of said core, said copper strands being distributed uniformly and concentrically on the periphery of said core so as to penetrate only partially into said core, with each of them leaving a portion that is accessible from outside said periphery, wherein said copper strands are embedded in part in the material forming the core and extend parallel to the longitudinal direction of said core.

Advantageously, the cable includes an insulating layer concentrically surrounding the core and the copper strands.

Furthermore, the cable may also include, at the center of said core, a strand that is made of polymer (e.g. a polyamide, a polycarbonate, or a polyethylene terephthalate), or of metal (e.g. steel).

The present invention also provides a method of fabricating the cable of the invention, wherein the method consists in embedding said copper strands during the step of fabricating said core by extruding a polymer material.

The fabrication method preferably includes a step of sheathing the cable in an insulating layer concentrically surrounding the core and said copper strands, preferably by extrusion, the cable itself optionally being reinforced by a central strand of high mechanical strength.

### BRIEF DESCRIPTION OF THE DRAWING

The invention and its advantages can be better understood in the light of the following description made with reference to the accompanying figures, in which:

FIG. 1, described above, is a cross-section of a control cable of the prior art;

FIG. 2 is a diagram of a cable of the present invention, seen in cross-section; and

FIG. 3 shows a variant of the FIG. 2 cable.

### MORE DETAILED DESCRIPTION

As a preliminary remark, it should be observed that the accompanying drawings are not to scale, but they nevertheless make it possible to compare different cables all having the same outside diameter, typically of the order of 1.6 mm. Furthermore, by way of non-limiting example, all of the cables shown present a section that is circular. Naturally, other shapes could be envisaged without going beyond the ambit of the present invention.

With reference to FIG. 2, a control cable of the invention comprises a core 10 of polymer material and a plurality of copper strands 20 extending in the longitudinal direction of the core 10. The copper strands 20 are distributed uniformly and concentrically around the periphery of said core, each offering a portion that is accessible from outside said periphery.

As shown in FIG. 2, the cable also has an insulating sheath 30 concentrically surrounding the core 10 and the copper strands 20.

In the invention, the strands are embedded at least in part during fabrication of the core 10, preferably by extrusion, and they extend parallel to the longitudinal direction of said core 10.

Thus, unlike prior art cables in which the strands are twisted, this cable is much easier to fabricate. In particular, this makes it possible to use a common machine for fabricating the core together with the partially embedded strands, followed by a sheathing operation, whereas with twisted strands of the prior art it is necessary to provide special equipment for twisting the strands around the core.

If the cable might be folded or kinked, in order to ensure that the strands on the outside of the fold do not break, it is preferable for the core to be made of a material that is very flexible and very soft, so as to enable the stressed strands to move towards the center of the cable. For example, it is possible to use a foam of polyurethane or of polyethylene.

In addition to being simple to fabricate, the cable of FIG. 2 presents the advantage of guaranteeing that an electrical connection is made with a connector bushing by crimping. Once the cable has been stripped, i.e. once the portion of its insulating sheath has been removed, a portion of each copper strand 20 can be accessed.

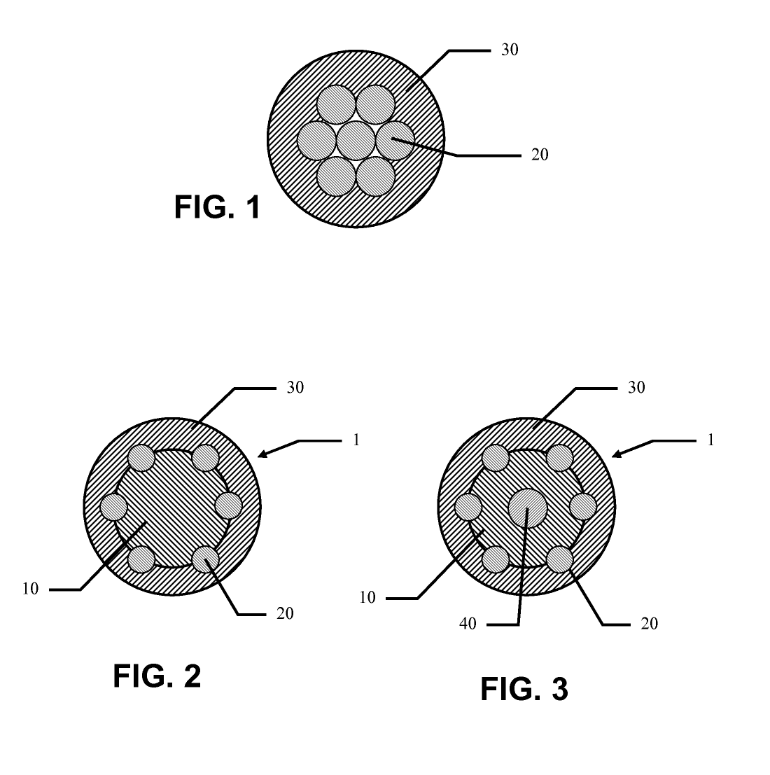

Furthermore, as can be seen by comparing FIGS. 1 and 2, for the same outside diameter of cable, and for a core 10 presenting substantially the same diameter as the braid formed by the seven strands of FIG. 1, not only is the number of strands used smaller (six strands in FIG. 2), but the diameter of these strands is also smaller (a diameter of about 0.2 mm per strand instead of a diameter of 0.3 mm per strand in FIG. 1). This leads to a considerable decrease in the cost and the weight of the cable.

FIG. 3 shows a variant embodiment of the FIG. 2 cable in which a strand 40 is placed at the center of the core 10 so as to increase the traction strength of the cable. This strand 40 may be made of metal (e.g. of steel). In a variant, it is also possible to use a strand made of polymer (such as polyamide, polycarbonate, or polyethylene terephthalate).

What is claimed is:

1. An electric control cable of the type comprising a core of polymer material and a plurality of copper strands extending in the longitudinal direction of said core, said copper strands being distributed uniformly and concentrically on the periphery of said core so as to penetrate only partially into said core, with each of them leaving a portion that is accessible from outside said periphery, wherein said copper strands are embedded in part in the material forming the core and extend parallel to the longitudinal direction of said core.

2. An electric control cable according to claim 1, wherein the material forming the core is selected so as to make it possible, when the cable is folded, for the copper strands that are on the outside of the fold to move towards the center of the cable.

3. An electric control cable according to claim 2, wherein the material forming the core is a foam of polyurethane or of polyethylene.

4. An electric control cable according to claim 1, including an insulating layer concentrically surrounding the core and said copper strands.

5. An electric control cable according to claim 1, including a polymer or metal strand at the center of said core.

6. A method of fabricating a cable according to claim 1, the method consisting in embedding said copper strands during the step of fabricating said core by extruding a polymer material.

7. A fabrication method according to claim 6, including a step of sheathing the cable in an insulating layer concentrically surrounding the core and said copper strands, preferably by extrusion.
